(19) United States
(12) Patent Application Publication
(10) Pub. No.: US 2014/0280147 A1
(43) Pub. Date: Sep. 18, 2014

(54) DATABASE ONTOLOGY CREATION

(71) Applicants: Knarig Arabshian, New York, NY (US); Peter Danielsen, Naperville, IL (US)

(72) Inventors: Knarig Arabshian, New York, NY (US); Peter Danielsen, Naperville, IL (US)

(21) Appl. No.: 13/834,038

(22) Filed: Mar. 15, 2013

(51) Int. Cl. G06F 17/30

(52) U.S. Cl. CPC G06F 17/30705
USPC 707/737

(57) ABSTRACT

According to an example embodiment, a device for providing information regarding database contents includes data storage and a processor associated with the data storage. The processor identifies a database including a plurality of members and feature information regarding at least one feature of the members, respectively. The processor determines at least one categorizing indicator from a source that is external to the database and determines whether there are any associated indicators in the feature information that correspond to the categorizing indicator. The processor identifies the members of the database having the associated indicators and associates the identified members with a category based on the categorizing indicator.

### BACKGROUND

The amount of information and the availability of services on the Internet continues to increase but the accessibility to a user may not be intuitive or automatic. In order to make good use of available information and services individuals need to know what is within that which is available. If an individual is not able to easily locate potentially useful services and identify their contents, they may be available but go unused or be overlooked by potential users.

For example, a current trend involves creating web service mashups, which allow users to create their own content from different types of sources such as websites, RSS Feeds or Flicker. A user is able to filter tailored information on a personal page to view and share with others. It is not necessary for the user to know how to create a website. Instead, the user can simply bring together different components through a simplified user interface.

There are a variety of web services in different domains, such as social media or mapping services that offer their APIs for use in mashup applications. Unfortunately, there is no readily understandable categorization of many of these services. Current ontology generation often includes an established taxonomy or a structured corpus so that it may be difficult or impossible to generate a useful or understandable categorization of high level properties within a generic classification.

### SUMMARY

According to an example embodiment, a device for providing information regarding database contents includes data storage and a processor associated with the data storage. The processor identifies a database including a plurality of members and feature information regarding at least one feature of the members, respectively. The processor determines at least one categorizing indicator from a source that is external to the database and determines whether there are any associated indicators in the feature information that correspond to the categorizing indicator. The processor identifies the members of the database having the associated indicators and associates the identified members with a category based on the categorizing indicator.

According to an example embodiment, a method of providing information regarding database contents includes identifying a database including a plurality of members and feature information regarding at least one feature of the members, respectively. At least one categorizing indicator is determined from a source that is external to the database. The method includes determining whether there are any associated indicators in the feature information that correspond to the categorizing indicator and identifying the members of the database having the associated indicators. The identified members are associated with a category based on the categorizing indicator.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a device designed according to an embodiment of this invention that is configured to facilitate organizing information regarding database contents.

FIG. 2 is a flowchart diagram summarizing an example method of providing information regarding database contents according to an embodiment of this invention.

### DETAILED DESCRIPTION

FIG. 1 schematically illustrates selected portions of a system 20 for providing information regarding the contents of a database. A computing device 22 includes a processor 24 and data storage 26 associated with the processor 24. The data storage 26 may include computer-executable instructions that are executed by the processor 24 as the device 22 performs the operations described below. The processor 24 may also place information into the data storage 26 and access information from the data storage 26.

The device 22 includes a user interface 28 that allows at least one user to interact with the device 22 to provide input information and to obtain an output from the device 22. The user interface 28 in one embodiment includes at least one input feature, such as a keyboard or a mouse pointer, and at least one output feature, such as a display screen.

A database 30 includes a plurality of members with only two of them shown in the illustration at 32 and 34. Of course, a typical database with which the device 22 will be used will include many (perhaps thousands) of database members. The database 30 also includes some feature information regarding the respective members schematically shown at 36. The members of the database will depend on the particular database and embodiments of this invention may be useful with a wide variety of databases. For discussion purposes, a database of application programming interfaces (APIs) will be considered. One such database is available on the Internet at www.programmableweb.com. The APIs within the Programmable Web database are the members 32, 34 in this example. The Programmable Web database includes some information regarding the various APIs that are accessible. While general and broad categories are set up for that database, it can be difficult and very time consuming to identify particular APIs that may be useful for particular tasks or purposes. This is especially true for individuals who may not have much experience or familiarity with a given subject.

The Programmable Web database may have more than 5000 APIs that are divided into 56 high-level categories. There also is descriptive information regarding each of the APIs, which information is typically supplied by the API provider. The information regarding the APIs in this example is the feature information 36. Such information is not easily digested by an individual seeking to locate at least one API for a particular purpose. For example, the wording used in the feature information 36 may be unfamiliar to that individual and it may not be possible to determine which parts of the information are important or relevant to a particular situation. Further, the large number of members 32, 34 (e.g., APIs) can make it very difficult for an individual to identify the most suitable API within a reasonable time.

The device 22 provides an individual with the ability to obtain useful information regarding the members of the database 30 and generates an ontology (i.e., structured, organizational information) of the database 30. In one example, the device 22 is semi-automated in that it operates, at least in part, based on user input that is indicative of the manner in which the user desires the ontology to be established. The level of automation and the amount of user input or selection required may vary depending on the particular implementation.

One feature of the device 22 is that it utilizes information from at least one source that is external to (i.e., distinct from) the database 30 for generating the ontology of the database contents. FIG. 1 schematically shows three external sources 40, 42 and 44 for discussion purposes. Of course, fewer sources or more could be used in a particular implementation. Example sources include Wikipedia, Wordnet, online dictionaries, and online glossaries of terms used in particular industries. The external source provides information to the processor 24 regarding key terms within a field or area of interest that has been identified by the user. The processor 24 is configured to automatically access an appropriate or user-selected source 40-44, identify such terms and use the identified terms as categorizing indicators that facilitate ontology generation. A “categorizing indicator” may be, for example, a key word or a term used for describing an aspect or feature of various APIs that also provides a useful label for a category within the ontology in which such APIs should be included. This feature of the example device 22 allows a user to create an ontology of the database 30 even when the user does not have specialized knowledge about the field or area of interest.

The manner in which the device 22 operates according to one embodiment may be understood by considering the flowchart 50 of FIG. 2. At 52, the processor 24 identifies the database 30 of interest. This may be accomplished, for example, based on user input indicating the database of interest, such as the Programmable Web database. In that case, the members 32, 34 of the database 30 are the APIs.

The identification that is accomplished at 52 in one example embodiment includes the processor 24 analyzing the feature information 36 of the identified database. For example, the processor 24 uses known natural language processing (NLP) techniques to extract terms from the API text descriptions contained within the feature information 36. Such terms may be useful as distinguishing features of the associated API(s). One example includes generating two lists: a top N list of text frequency—inverse document frequency (TF-IDF) ranked terms and a list of two-termed significant phrases.

The TF-IDF score of a word shows how important that word is within the corresponding feature information 36. Importance of a word in a particular context depends, for example, on how frequently the word is used in that context and how common the word is in all of the considered information.

A significant phrase includes two or more words. A list of such phrases may be useful in addition to single term TF-IDF ranked words as high level property descriptions. Significant phrase generation in one example is based on a two-phase process. First, collocations (i.e., terms that appear together) are determined. Then unique collocations are filtered out from the list.

One example includes using a Chi-square test to calculate the significance of the collocated words. Such a test can measure how often the words in a phrase appear together and how often they appear separately or individually. For example, if the word “social” appears eight times, the word “stream” appears eight times and “social stream” appears eight times, then “social stream” is considered a significant phrase as there is a high correlation of these words appearing together as a phrase. To calculate the Chi-square probability of an n-length phrase, a n-by-n table is constructed and the Chi-square sums the differences between observed and expected values in all squares of the table.

Once the collocations are determined the listing is filtered to identify or find the unique phrases to determine the distinct properties. This portion of the process is useful to filter out phrases that are irrelevant because they appear in most API descriptions and are not important for identifying any unique or particular features of any one API.

Finding the distinctive phrases in the feature information 36 in one example includes creating testing sets and training sets. The testing set is generated from the feature information of the API under consideration. The training sets, on the other hand, are generated using all the APIs that are not in the same general category as those that are of interest. Frequencies of n-grams in the training set and frequencies of n-grams in the testing set are determined in some examples. N-grams in the testing set are sorted according to their significant score, which is the z score for binomial distribution.

At 54, the processor 24 determines at least one categorizing indicator from at least one external source 40-44. For example, consider a situation in which an individual desires to use an API that is useful for developing website content that is pertinent to marketing. The processor 24 consults an external source of information such as a Wikipedia page discussing marketing. The processor 24 uses potentially relevant external sources to identify terms that are used within a field or area as indicators of significant or important features that may serve as a basis for categorizing the members 32, 34 (APIs) of the database 30.

For example, the top twenty words, in terms of occurrence frequency, from the advertising page of Wikipedia are identified by the processor 24 using known search techniques, such as NPL techniques. The processor 24 in this example ranks the determined categorizing indicators (e.g., the top twenty words). The processor 24 also searches for synonyms that may be related to the categorizing indicators, for example, using Wordnet. In one example, the user interface provides an output informing a user of the categorizing indicators that were obtained from the external source 40-44 and their ranking.

At 56, the processor 24 determines if any indicator or term from the feature information associated with an API corresponds to one of the top words or categorizing indicators from step 54. When a reasonably certain match is located, the associated API (database member) is identified as having an associated indicator corresponding to the categorizing indicator at 58. One example includes presenting the associated indicators in ranked order according to the ranking of the categorizing indicators in step 54. Any corresponding word from the feature information 36 for that API is ranked higher than another that does not appear as a categorizing indicator from the external source.

At 60 the identified APIs (i.e., database members 32, 34) are associated with a category based on the categorizing indicator. Multiple categories including sub-categories may be established. The processor 24 creates the associations between APIs and ontology categories in one example based on a user selecting a categorizing indicator to identify a category of interest. This allows a user to influence how the ontology is structured and what it includes. One example includes presenting the user with an indication of the APIs that are considered appropriate for a category and the user has the ability to remove any of those APIs that the user would prefer not be in that category. It can be appreciated how the significant terms obtained automatically from the external source 40-44, which serve as the categorizing indicators, assist a user in determining how to organize the members of the database into an ontology in a manner that is helpful or informative to a particular user without requiring that user to be previously informed about significant aspects of the subject matter that corresponds to the category.

One feature of the illustrated example is that the processor 24 allows a user to customize the way in which a particular category is labeled within the ontology. For example, the phrase or term from the external source can be edited and then used as a heading to identify the corresponding category in the ontology. This user-based inclusion in the ontology makes the illustrated example capable of being semi-automated. Some embodiments do not require such user input and they may, therefore, be considered more automated or fully automated.

Another feature of the illustrated example is that the processor 24 stores information in the data storage 26 regarding any generated ontologies. This feature is useful for continuing an ontology generation process at a later time or for updating an ontology in the event that the database contents are updated. The processor 24 also provides an indication that is perceivable through the user interface 28 (e.g., color coding) to distinguish any members or category identifiers that are already within a particular portion of an ontology and those members that are not yet included in that portion of the ontology.

If an ontology for the portion of the database 30 under consideration has already been at least partially generated, the processor 24 determines if there are any terms in the ontology that match the top words (i.e., the categorizing indicators) from the external source 40-44 and ranks any such terms in a manner that indicates that they are being used in the ontology. Additionally, the processor 24 provides an indication (e.g., color coding) that distinguishes the terms already included in the ontology from newer or previously unused terms. This feature avoids duplicate categories within the ontology and facilitates a user recognizing work that has already been done on a previous version of the ontology.

The disclosed example device and method provide an automated tool that allows a user to create an ontology that organizes contents of a database. The disclosed example makes ontology generation possible even for individuals without expertise or previous knowledge regarding a subject area that the database members fit within. The manner in which the example device 22 accesses information (i.e., the categorizing indicators) from one or more sources external to the database 30 enables a user to obtain meaningful guidance regarding categories for organizing the database contents.

While a database of APIs was considered for discussion purposes, those skilled in the art who have the benefit of this description will realize that there are other types of databases that could be used. A device having features like those of the device 22 described above will be useful for generating an ontology to provide a useful, organization of a variety of types of database members so that they are more accessible to a user.

The preceding description is illustrative rather than limiting in nature. Variations and modifications to at least one disclosed example may become apparent to those skilled in the art that do not necessarily depart from the essence of the contribution to the art provided by the disclosed example. The scope of legal protection can only be determined by studying the following claims.

We claim:

1. A device for providing information regarding database contents, the device comprising:
a data storage; and
a processor associated with the data storage, the processor being configured to:
identify a database including a plurality of members and feature information regarding at least one feature of the members, respectively;
determine at least one categorizing indicator from a source that is external to the database;
determine whether there are any associated indicators in the feature information that correspond to the categorizing indicator;
identify the members of the database having the associated indicators; and
associate the identified members with a category based on the categorizing indicator.

2. The device of claim 1, wherein
the feature information comprises a plurality of terms;
the categorizing indicator comprises at least one term.

3. The device of claim 2, wherein
the processor is configured to automatically identify terms used by the source to describe at least one feature of subject matter within a selected category.

4. The device of claim 3, wherein the processor is configured to
identify the terms from a plurality of sources, respectively; and
provide an indication of the source of each identified term.

5. The device of claim 1, wherein the processor is configured to
generate an ontology of the database including the category with the associated members being organized based on the category.

6. The device of claim 5, wherein the processor is configured to
determine a plurality of categorizing indicators from at least one source external to the database;
determine whether there are any associated indicators in the feature information that correspond to each of the categorizing indicators, respectively; and
identify the members of the database having associated indicators;
associate the identified members with respective categories based on the respective categorizing indicators; and
include the respective categories in the generated ontology, wherein the database members are organized according to identified categories.

7. The device of claim 1, wherein
the database members comprise application programming interfaces;
the associated indicators comprise terms describing at least one feature of the associated application programming interface; and
the categorizing indicators comprise terms from a resource that provides information regarding a selected topic corresponding to a candidate category that would be suitable for at least one of the application programming interfaces.

8. The device of claim 1, wherein the processor is configured to
identify the database based on user input indicative of a user selection of the database;
select the source based on user input indicative of a user selection of the source external;
associate a descriptor with the category based on user input indicative of the descriptor.

9. The device of claim 1, wherein the processor is configured to
determine a rank of the associated indicators based on a selected criteria; and
present the associated indicators in a manner that is indicative of the rank.

10. The device of claim 1, wherein the processor is configured to
place information in the data storage regarding any of the database members that has been associated with the category; and
provide an indication distinguishing any of the database members that has been associated with the category previously from any of the database members that has not been previously associated with the category.

11. A method of providing information regarding database contents, comprising the steps of:
identifying a database including a plurality of members and feature information regarding at least one feature of the members, respectively;
determining at least one categorizing indicator from a source that is external to the database;
determining whether there are any associated indicators in the feature information that correspond to the categorizing indicator;
identifying the members of the database having the associated indicators; and
associating the identified members with a category based on the categorizing indicator.

12. The method of claim 11, wherein
the feature information comprises a plurality of terms;
the categorizing indicator comprises at least one term;
and the method comprises
automatically identifying terms used by the source to describe at least one feature of subject matter within a selected category.

13. The method of claim 11, comprising
identifying categorizing indicators from a plurality of sources, respectively; and
providing an indication of the source of each identified categorizing indicator.

14. The method of claim 11, comprising
generating an ontology of the database including the category with the associated members being organized based on the category.

15. The method of claim 14, comprising
determining a plurality of categorizing indicators from at least one source external to the database;
determining whether there are any associated indicators in the feature information that correspond to each of the categorizing indicators, respectively; and
identifying the members of the database having associated indicators;
associating the identified members with respective categories based on the respective categorizing indicators;
including the respective categories in the generated ontology; and
organizing the database members according to identified categories.

16. The method of claim 11, wherein
the database members comprise application programming interfaces;
the associated indicators comprise terms describing at least one feature of the associated application programming interface; and
the categorizing indicators comprise terms from a resource that provides information regarding a selected topic corresponding to a candidate category that would be suitable for at least one of the application programming interfaces.

17. The method of claim 11, comprising
identifying the database based on user input indicative of a user selection of the database;
selecting the source based on user input indicative of a user selection of the source external;
associating a descriptor with the category based on user input indicative of the descriptor.

18. The method of claim 11, comprising
determining a rank of the associated indicators based on a selected criteria; and
presenting the associated indicators in a manner that is indicative of the rank.

19. The method of claim 11, comprising
storing information regarding any of the database members that has been associated with the category; and
providing an indication distinguishing any of the database members that has been associated with the category previously from any of the database members that has not been previously associated with the category.

20. A non-transitory computer readable medium containing a plurality of computer-executable instructions, comprising instructions for:
identifying a database including a plurality of members and feature information regarding at least one feature of the members, respectively;
determining at least one categorizing indicator from a source that is external to the database;
determining whether there are any associated indicators in the feature information that correspond to the categorizing indicator;
identifying the members of the database having the associated indicators; and
associating the identified members with a category based on the categorizing indicator.
